(19) United States
(12) Patent Application Publication
(10) Pub. No.: US 2014/0037800 A1
(43) Pub. Date: Feb. 6, 2014

(54) Interlinking Candy Pieces

(71) Applicant: Robin Reichelt, Orange, CA (US)

(72) Inventor: Robin Reichelt, Orange, CA (US)

(21) Appl. No.: 14/047,799

(22) Filed: Oct. 7, 2013

Related U.S. Application Data
(63) Continuation-in-part of application No. 12/566,386, filed on Sep. 24, 2009, now abandoned.
(60) Provisional application No. 61/100,527, filed on Sep. 26, 2008.

(51) Int. Cl. A23G 3/34

(52) U.S. Cl. CPC A23G 3/343
USPC 426/104; 426/383

(57) ABSTRACT

Various shapes, sizes and colors of candy pieces can be serially interlinked into a garland of at least three pieces, using first and second spaced apart concave regions of the candy pieces. Each of the regions preferably measures at least one inch in length and has an inner portion. At least two of the candy pieces can be combined with a decorative background or card in a package.

This application is a continuation-in-part of U.S. application Ser. No. 12/566,386, filed Sep. 24, 2009, which claims priority to U.S. Provisional Application No. 61/100,527, filed on Sep. 26, 2008, which is incorporated by reference in its entirety. Where a definition or use of a term in an incorporated reference is inconsistent or contrary to the definition of that term provided herein, the definition of that term provided herein applies and the definition of that term in the reference does not apply.

### FIELD OF THE INVENTION

This invention pertains to the field of candy, especially as it relates to interlinking candy pieces.

### BACKGROUND

It is known to make garlands out of paper or cloth, by coupling loops end to end. That method doesn't work for candy pieces, however, because candies typically cannot be bent, and in any event don't have sufficient coupling areas.

One solution is to use string or other material to interconnect the candies. That works well for gelled candies because consumers can readily use a needle to thread together multiple various pieces. Threading works very poorly, or not at all, for hard candies, because they are difficult to puncture and tend to crack. Neither solution works well for candy canes, which have a pole or “J” shapes that preclude serial coupling.

One solution is to wrap a string or ribbon about individual pieces of candy, but some people find that unattractive. Another solution is to place the candies in individual plastic wrappers, and then string the wrappers. But there again the result can be unattractive.

Therefore, there remains a need in the art for shapes, systems and methods that permit candy canes and other hard candy pieces to be interlinked to create decorative garlands.

### SUMMARY OF THE INVENTION

The inventive subject matter provides various shapes, sizes and colors of candy pieces that can be serially interlinked into a garland of at least three pieces using first and second spaced apart concave regions of the candy pieces. Each of the regions preferably measures at least one inch in length and has an inner portion. As used herein, the term “spaced apart regions” means that the regions are non-overlapping, and separated by at least a half inch. As used herein, the term “concave” means a region having an inward bending portion, whether angular or curved. Under this definition, a square, an ellipse, and a circle of sufficient size each have at least two spaced apart concave regions. Similarly, a normal sized, traditional “J”-shaped candy cane has only a single concave region, but a large candy cane could have multiple spaced apart concave regions.

Unless a contrary intent is apparent from the context, all ranges recited herein are inclusive of their endpoints, and open-ended ranges should be interpreted to include only commercially practical values. Similarly, all lists of values should be considered as inclusive of intermediate values unless the context indicates the contrary.

Preferred candy pieces have an elongated body with an approximately circular cross-section, though other commercially-suitable shapes are also contemplated. As used herein, the term “elongated” means a body that has an aspect ratio of at least 5:1.

In some embodiments, the candy pieces have striped patterns that include a series of alternating colors. Though traditional candy canes have alternating red and white stripes, other color(s) and/or combination(s) of colors are also contemplated. Additionally or alternatively, the stripes could have similar or varied widths, and/or could include three or more colors. In other contemplated embodiments, the candy pieces could have other patterns, including for example, solid patterns, polka dotted patterns, checkered patterns, and so forth.

The candy pieces can advantageously be a confection that is edible, and can include a sugar or sugar substitute such that the candy pieces have a sweet taste. Preferred candy pieces have a peppermint flavor, though all commercially-suitable flavors are contemplated.

The inner portions of the candy pieces can advantageously form concavities that facilitate coupling of the candy pieces to one or more adjacent candy pieces. Alternatively, the inner portions can be more angular, and preferably form an angle between 75 and 105 degrees.

Contemplated candy pieces can include an opening such as to allow the candy piece to couple to a concave region of an adjacent candy piece, or to some other structure (e.g., a hook or a tree branch). Preferred openings face an apex of at least one of the concave regions.

The candy pieces can have any commercially suitable shape, including for example, heart shapes, figure 8 shapes including those having an open end, “C” shapes, horseshoe shapes, square shapes, “S” shapes, and ovoid shapes, where the term “ovoid” is defined herein to include circular and degenerate oval shapes. In addition, the candy pieces can have any commercially suitable size and dimension.

Preferred candy pieces have an outer wrapping or coating such as to shield the candy piece from the external environment and thereby help the candy pieces retain their freshness and taste.

In one aspect, at least two of the candy pieces are packaged with a decorative back-ground, such as a collectible holiday themed card, for example. Preferably, at least five candy pieces are included in the package, such that a consumer who purchases the package could create a chain of the candy pieces.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1-7 illustrate various embodiments of a candy piece.

FIG. 8 illustrates an embodiment of a packaging containing five candy pieces.

FIGS. 9-12 illustrate embodiments of decorative chains formed by interlinking the candy pieces.

FIG. 13 is an embodiment of a package containing a decorative card and five candy pieces.

FIG. 14 is another embodiment of a decorative garland composed of candy pieces.

### DETAILED DESCRIPTION

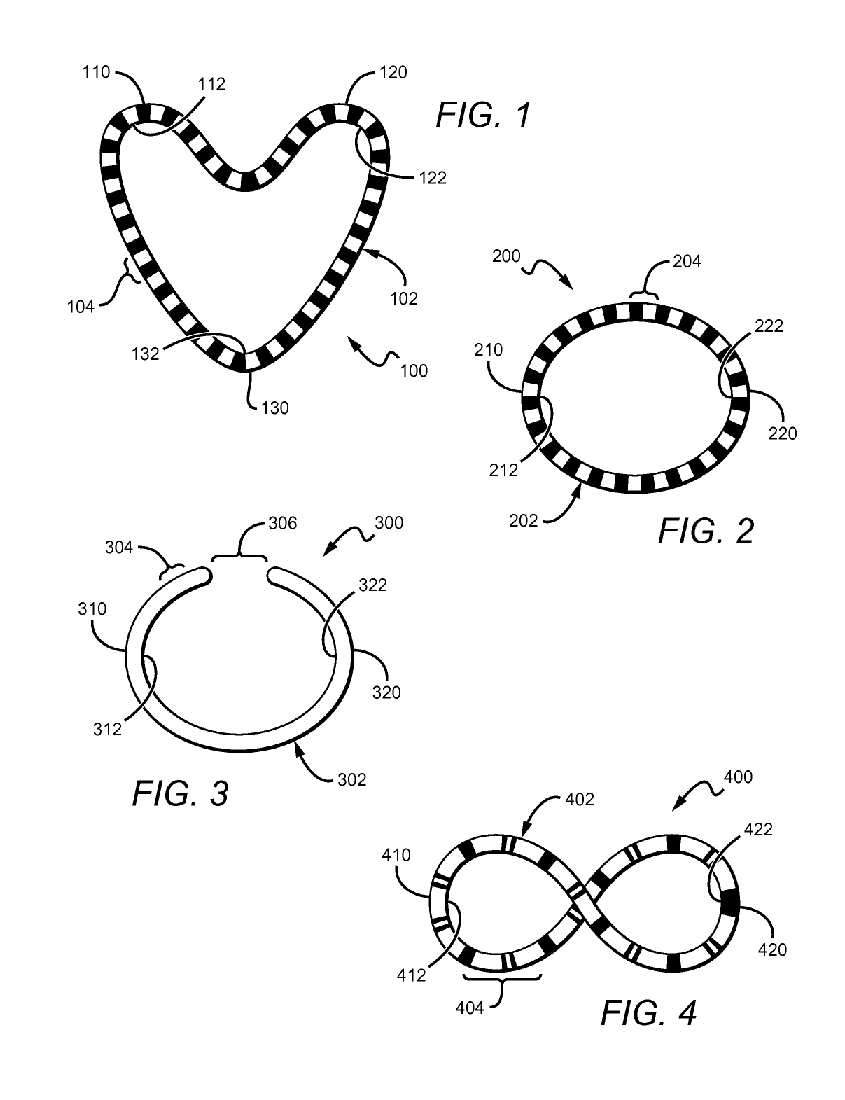

Contemplated candy pieces can come in a variety of shapes including, for example, those shown in FIGS. 1-7.

In FIG. 1, candy piece 100 includes first, second, and third spaced apart concave regions 110, 120, and 130. Each of the concave regions 110, 120, and 130 has a corresponding inner portion 112, 122, and 132, respectively, that forms an acute angle. Candy piece 100 includes an elongated body 102 oriented in a “heart” shape, though all commercially suitable shapes are contemplated.

Body 102 has a striped pattern 104 that includes a combination of thicker and thinner stripes. Alternatively, body 102 could have different pattern(s) including, for example, stripes of similar widths such that each stripe has a width within one-sixteenth of an inch of the width of the other stripes. Preferred stripes have alternating red and white coloring, though all color combination(s) are contemplated, including for example, different colors, different numbers of colors, and different patterns of colors.

FIG. 2 illustrates candy piece 200 having an elongated body 202 oriented in an ovoid. FIG. 3 illustrates candy piece 300 having an elongated body 302 oriented in a “C” shape, and having an opening 306. FIG. 4 illustrates candy piece 400 having an elongated body 402 oriented in a figure 8. With respect to the remaining numerals in each of FIGS. 2-4, the same considerations for like components with like numerals of FIG. 1 apply.

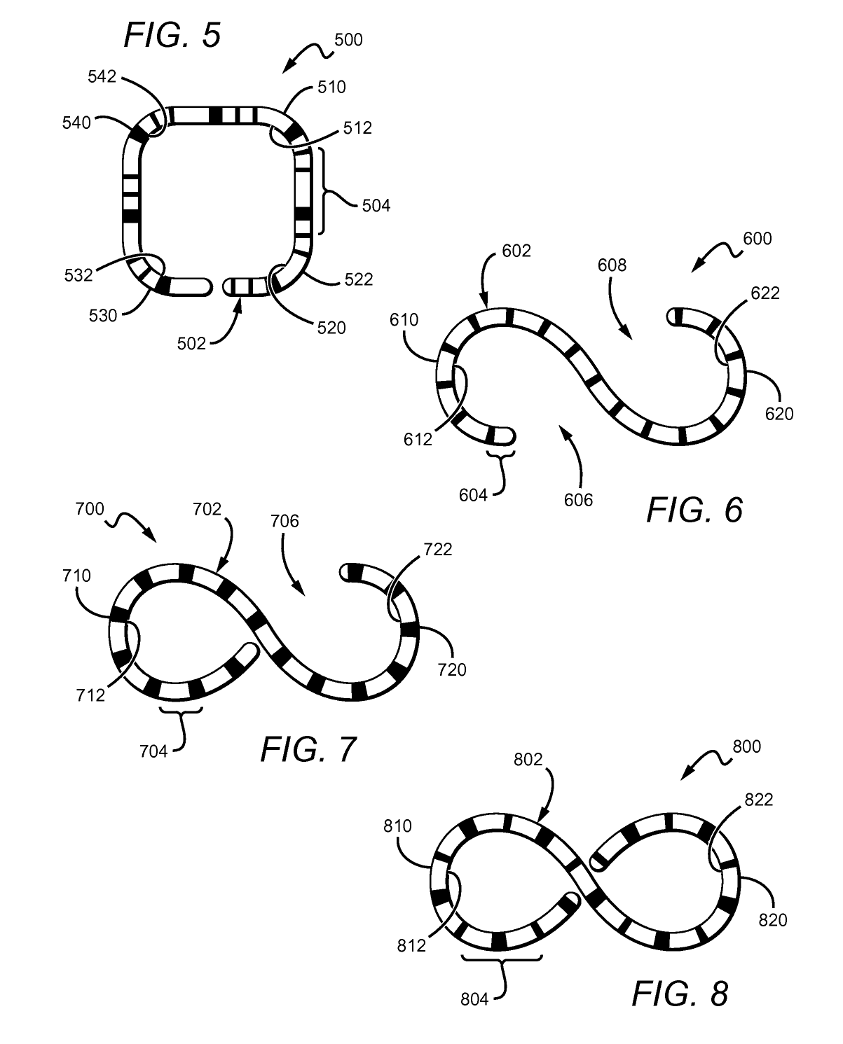

FIG. 5 illustrates candy piece 500 having an elongated body 502 oriented in a square shape with rounded right angles. Candy piece 500 includes four concave regions 510, 520, 530, and 540 that each includes a corresponding inner portion 512, 522, 532, and 542, respectively. Each of the inner portions 512, 522, 532, and 542 forms an angle of approximately 90 degrees. With respect to the remaining numerals in FIG. 5, the same considerations for like components with like numerals of FIG. 1 apply.

FIG. 6 illustrates candy piece 600 having an elongated body 602 oriented in an “S” shape, and having first and second openings 606 and 608. FIG. 7 illustrates candy piece 700 having an elongated body 702 oriented in a FIG. 8, and having an opening 706. FIG. 8 illustrates candy piece 800 having an elongated body 802 oriented in a non-overlapping figure 8. With respect to the remaining numerals in each of FIGS. 6-8, the same considerations for like components with like numerals of FIG. 1 apply.

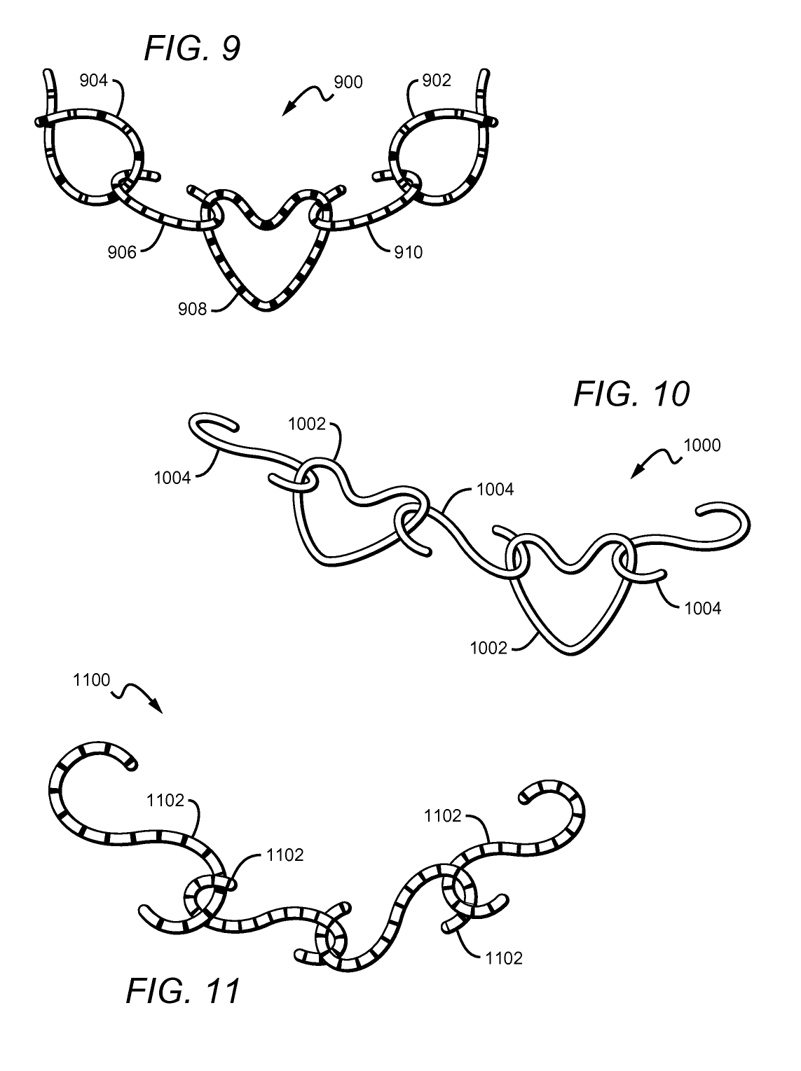

As shown in FIG. 9, candy pieces 902-910 can be coupled to form candy chain 900. The assembled candy chain 900 can be hung from the branches of a tree, or elsewhere in a home business, or even outdoors.

FIG. 10 illustrates candy chain 1000 having a solid pattern. The candy chain 1000 is formed from the coupling of alternating heart shaped candy pieces 1002 and “S” shaped candy pieces 1004. However, all commercially suitable combination(s) of pieces are contemplated, including for example, a plurality of “C” shaped pieces, alternating “C” shaped and heart shaped pieces, a plurality of “C” shaped, heart shaped, and figure 8 shaped pieces, and any combination(s) thereof.

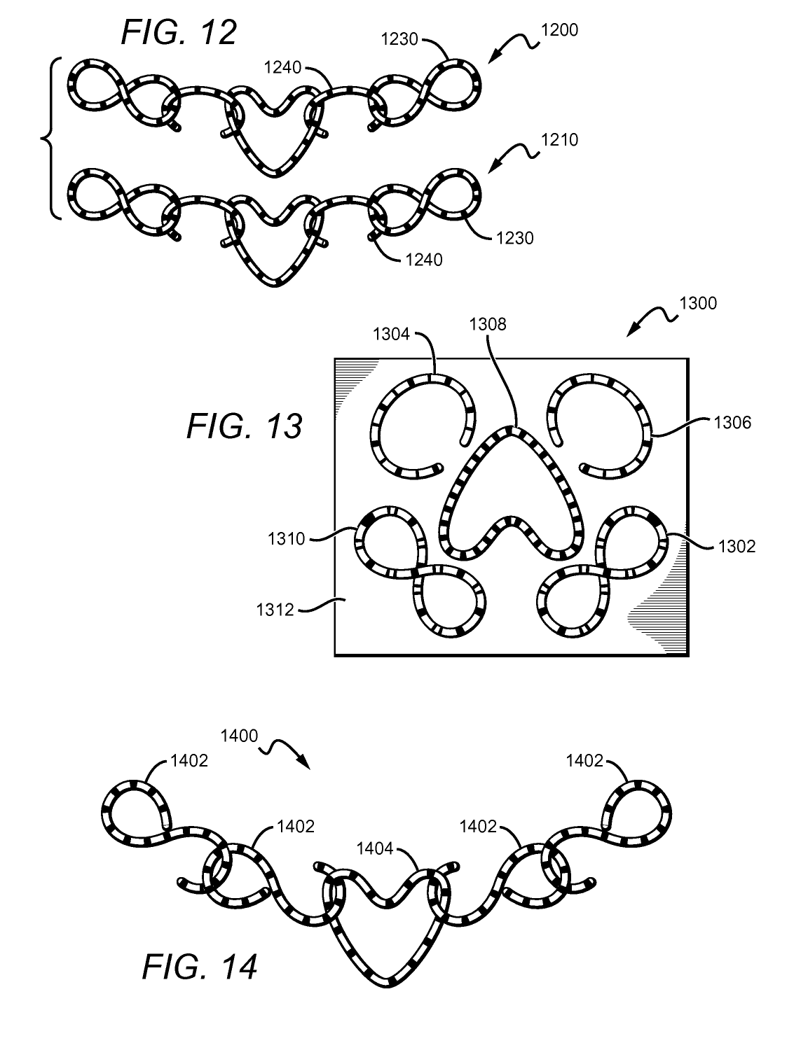

In FIG. 11, candy chain 1100 is shown having a series of “S” shape candy pieces 1102. FIG. 12 illustrates candy chains 1200 and 1210, each of which are formed from alternating figure 8 shaped candy pieces 1230 and “C” shaped candy pieces 1240.

In FIG. 13, package 1300 includes a decorative card 1312 and five candy pieces 1302-1310, though contemplated packages can include any commercially suitable number of candy pieces. Preferred packages include a combination of differently shaped candy pieces such that a chain can be formed. Thus, for example, the candy pieces 1302-1310 could be assembled to form a chain such as those shown in FIG. 9.

FIG. 14 illustrates candy chain 1400 composed of figure 8 shaped candy pieces 1402 having an open end, and a heart shaped candy piece 1404.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for making a garland to hang from a tree or other surface, comprising:
at least five candy cane pieces, each of which is identical in size and shape;
wherein each of the candy cane pieces have first and second opposite-facing, concave regions; and
wherein each of the candy cane pieces has one opening to allow connection of the at least five candy cane pieces in a series.

2. The system of claim 1, wherein each of the at least five candy cane pieces are individually wrapped to shield each of the candy cane pieces from an external environment.

3. The system of claim 1, wherein each of the at least five candy cane pieces is “C”-shaped.

4. The system of claim 1, wherein each of the candy cane pieces comprises a repeating pattern of a thick stripe followed by three thin stripes.

5. The system of claim 1, wherein each of the candy cane pieces comprises first and second hooks.

6. The system of claim 1, wherein each of the candy cane pieces is rigid and has a striped pattern.

7. A system for making one or more garlands to hang from a tree or other surface, comprising:
a plurality of wrapped, candy cane pieces;
wherein each of the candy cane pieces have first and second opposite-facing, concave regions; and
wherein at least one of the candy cane pieces comprises an opening to allow connection of the candy cane piece to two adjacent candy cane pieces of the plurality of pieces to form a garland.

8. The system of claim 7, wherein each of the plurality of candy cane pieces are identical in size and shape.

9. The system of claim 7, wherein the plurality of candy cane pieces comprises different shapes.

10. The system of claim 7, wherein at least one of the candy cane pieces is closed.

11. The system of claim 7, wherein the plurality of candy cane pieces comprises at least five pieces.

12. The system of claim 7, wherein the plurality of candy cane pieces are configured such that they can be connected in series to form a garland.

13. The system of claim 7, wherein at least some of the candy cane pieces comprises a “C”-shape.

14. The system of claim 7, wherein each of the at least five candy cane pieces are individually wrapped to shield each of the candy cane pieces from an external environment.

15. The system of claim 7, wherein each of the candy cane pieces comprises first and second hooks.

16. A method of making a garland, comprising:
providing a plurality of candy cane pieces; and
instructing a user to serially interlink the candy cane pieces to form the garland.

17. The method of claim 16, wherein each of the candy cane pieces comprises first and second spaced apart concave regions, and wherein the step of instructing the user further comprises instructing the user to serially interlink the candy cane pieces using the spaced apart concave regions to form the garland.

18. The method of claim 17, wherein the spaced apart concave regions of each piece are opposite facing.

19. The method of claim 16, wherein each of the candy cane pieces is wrapped.

20. The method of claim 16, wherein each of the candy cane pieces is “C”-shaped.
